(19) United States
(12) Patent Application Publication
(10) Pub. No.: US 2018/0010291 A1
(43) Pub. Date: Jan. 11, 2018

(54) PLANAR TEXTILE SUBSTRATE WITH A WATER-ACTIVATED ADHESIVE COATING, METHOD FOR ITS PRODUCTION AND USE THEREOF

(71) Applicant: VITRULAN TEXTILE GLASS GMBH, Marktschorgast (DE)

(72) Inventors: Heiko ZETTL, Bayreuth (DE); Gunnar ZAPF, Untersteinach (DE)

(73) Assignee: VITRULAN TEXTILE GLASS GMBH, Marktschorgast (DE)

(21) Appl. No.: 15/542,869

(22) PCT Filed: Dec. 30, 2015
(86) PCT No.: PCT/EP2015/081418

§ 371 Date: Jul. 11, 2017

(30) Foreign Application Priority Data
Jan. 14, 2015 (DE) 10 2015 200 453.8

(51) Int. Cl. D06N 3/02; C09J 103/02; D06N 7/00

(52) U.S. Cl. CPC D06N 3/02; D06N 7/0073; D06N 7/0002; C09J 103/02; D06N 2203/026; D06N 2203/028

(57) ABSTRACT

The invention relates to a planar textile substrate comprising on a surface a coating that contains a water-activated adhesive, said adhesive representing an aqueous dispersion of the following composition.

The invention refers to a planar textile substrate that has a coating comprising an adhesive activatable by water on an outer side, wherein the adhesive represents an aqueous dispersion having the following composition:
a) 1 to 30 wt. % of at least one modified starch;
b) 10 to 60 wt. % of at least one dextrin;
c) 0.1 to 10 wt. % of at least one modified cellulose;
d) 0.1 to 20 wt. % of at least one compound selected from the group comprising polyvinyl acetates, ethylene vinyl acetates, polyacrylates, polyacrylamides, polymethacrylates, polyurethanes, polyvinylpyrrolidones and mixtures or corresponding copolymers thereof; and
e) 0 to 30 wt. % of at least one additive; and
f) 10 to 80 wt. % water.

The present invention furthermore relates to a method of manufacturing this planar textile substrate and to the use of the textile substrate as wallpaper, other wall or ceiling coverings as well as for door and furniture covers.

Wallpaper has been known for a long time from the prior art that has a dry paste coating that is moistened with water and thus activated before being e.g. applied to a wall so that the strip of wallpaper can be placed onto the wall. Such wallpaper is known, for example, from DE 2623 903 A1.

An important aspect in the prior art was previously that such coating materials demonstrate an initial adhesion in the wet state, but in so doing, however, simultaneously permit a movement for correction for a certain period of time.

It has, however, previously been disadvantageous in the methods known from the prior art that they cannot be non-destructively peeled off from the surface in the dry state once the adhesive has dried.

It was therefore the object of the present invention to provide textile substrates that are simple to handle both in hanging and in peeling off.

This object is achieved by the planar textile substrate having the features of claim 1 and by the method of its manufacture having the features of claim 17. Uses in accordance with the invention are given in claim 19. The further dependent claims show advantageous further developments.

In accordance with the invention, a planar textile substrate is provided that has a coating comprising an adhesive activatable with water on an outer side that represents the outer side that is brought into contact with a surface. The adhesive in this process represents an aqueous dispersion and has the following composition:
a) 1 to 30 wt. % of at least one modified starch;
b) 10 to 60 wt. % of at least one dextrin;
c) 0.1 to 10 wt. % of at least one modified cellulose;
d) 0.1 to 20 wt. % of at least one compound selected from the group comprising polyvinyl acetates, ethylene vinyl acetates, polyacrylates, polyacrylamides, polymethacrylates, polyurethanes, polyvinylpyrrolidones and mixtures or corresponding copolymers thereof;
e) 0 to 30 wt. % of at least one additive; and
f) 10 to 80 wt. % water.

In this process, components a) to e) add up to 100 wt. %.

Modified starch is to be understood as starch derivatives acquired by physical, enzymatic or chemical processes, in particular hydroxypropyl starch or acetylated starch.

Modified cellulose is to be understood as cellulose derivatives acquired by physical, enzymatic or chemical processes, in particular carboxymethyl cellulose or methyl cellulose.

The textile substrate in accordance with the invention is characterized by the fact that it can be removed from a surface substantially without residue in the dry state after application to the surface.

It is preferred in this respect that the adhesive in accordance with the invention can be activated by water a multiple of times so that the textile substrate can be removed from the substrate a multiple of times and can be fastened to the position again by a repeated moistening. This form of reactivatability of the adhesive thus makes possible access to the surface (e.g. on junction boxes) without afterward having to carry out a large-area reworking of the wall.

It is preferred that the adhesive comprises 3 to 20 wt. %, in particular 5 to 15 wt. % of component a); 15 to 45 wt. %, in particular 20 to 35 wt. %, of component b); 0.3 to 5 wt. %, in particular 0.5 to 3 wt. %, of component c); 1 to 10 wt. %, in particular 2 to 5 wt. %, of component d); and 20 to 70 wt. %, in particular 40 to 65 wt. %, of component f).

In a further preferred embodiment, the additives contained in the adhesive are selected from the group comprising
preservatives, in particular from the group of isothiazolinones, from the group of pyrithiones, from the group of imidazoles, from the group of carbamates, from the group of preserving solvents, in particular in quantities of 0 to 3 wt. %;
fillers, in particular calcium carbonates, kaolins, aluminum hydroxides, magnesium hydroxides, hollow glass spheres, glass spheres, polymer spheres, ceramic spheres or quartz powders, in particular in quantities of 0 to 30 wt. %;
fibers, in particular short fiberglass fiber, cellulose fibers or polyester fibers or other synthetic textile fibers or natural textile fibers such as cotton, in particular in quantities of 0 to 20 wt. %;
rheological additives, in particular acrylate thickeners, cellulose thickeners, polyurethane thickeners, thickeners based on urea or polyurea or polymer sugars, in particular in quantities of 0 to 10 wt. %;
wetting agents, in particular surfactants from the group of non-ionic, anionic or cationic surfactants, in particular in quantities of 0 to 10 wt. %;
anti-foaming agents, in particular anti-foaming agents based on mineral oil;
from the group of phosphates and polyphosphates or from the group of siloxanes, in particular in quantities of 0 to 10 wt. %;
foam stabilizers, in particular polysiloxanes, in particular in quantities of 0 to 10 wt. %;
mixtures thereof.

The coating in accordance with the invention preferably has a film thickness of 10 μm to 5 mm, in particular of 50 μm to 500 μm.

The textile substrate is preferably selected from the group comprising fabrics, non-wovens, knitted fabrics, knittings, non-crimp fabrics or combinations hereof.

It is particularly preferred that the textile substrate comprises fiberglass. It is, however, possible that the textile substrate comprises a mixed textile comprising fiberglass and fibers of other materials. These fibers of other materials are preferably selected from the group comprising
mineral fibers;
carbon fibers;
synthetic fibers, in particular polymer fibers, preferably of polyesters, polyamides, and polyurethanes;
viscous fibers, cellulose fibers;
natural fibers, in particular cotton, wool, kapok, hemp, linen, jute;
metal threads; and
mixtures thereof.

To achieve an adhesion of the textile substrate on the surface, it is preferred that the application quantity of the adhesive amounts in the dry state to 5 to 100 g/m², in particular 15 to 35 g/m².

A further preferred embodiment provides that the textile substrate has a coat of paint on the outer side of the textile substrate remote from the coating comprising the adhesive.

It is equally possible that the textile substrate additionally has a vinyl coating or a PVC coating.

Provision is made in a preferred embodiment that further functional elements are arranged between the textile substrate and the coating and are selected from the group comprising acoustic fleece, foam, a thermal insulation system, a heat storage system, a water-absorbing system, panel heating, an equalizing layer, an IR reflective layer, an odor-absorbing layer, a paramagnetic system or combinations thereof.

In accordance with the invention, a method is also provided of manufacturing a planar substrate comprising fiberglass and having a coating comprising an adhesive activatable by water such as has been previously described, in which method the at least one adhesive activatable by water is applied to at least one outer side of the textile substrate by means of a roller, a doctor blade (wiper blade, roller blade, comma blade, etc.), printing mechanism, screen print, curtain coater or slot die and is dried. The coating comprising the adhesive activatable by water can in this respect be applied as a foam or as a film.

The textile substrates in accordance with the invention are used in the form of wallpaper, for decorative wall and ceiling coverings, for reinforcing wall, roof, ceiling and floor linings indoors and outdoors, for decorative wall and ceiling covers, for decorative door and furniture covers, wherein they have a coat of paint or are free of a coat of paint.

The subject matter in accordance with the invention will be explained in more detail with reference to the following example without intending to restrict it to the specific embodiment shown here.

A dispersion in accordance with the invention was prepared that had the following composition:
23.3 parts hydroxypropyl starch;
70 parts dextrin;
4.4 parts EVA;
1.8 parts CMC;
0.5 parts of wetting agent (polyglycol ester); and
approx. 150 parts water.

The dispersion was applied to the rear of a fiberglass fabric by means of a roller blade and was dried in an air dryer. An application quantity of 20-25 g/m² was applied in a dry state for the experiment. In a subsequent practical trial, the fabric could be pulled off as a whole in a dry state both from different gypsum plasterboards and from screen print boards.

The fabric was partially pulled off from the wall for a test. After a moistening of the position by means of a conventional spray bottle, the pulled off region was able to be fastened to the wall again. A pull-off test after drying shows an adhesion to the surface equivalent to the first fastening.

1-19. (canceled)

20. A planar textile substrate that has a coating comprising an adhesive activatable by water on an outer side, wherein the adhesive is an aqueous dispersion having the following composition:
a) 1 to 30 wt. % of at least one modified starch,
b) 10 to 60 wt. % of at least one dextrin;
c) 0.1 to 10 wt. % of at least one modified cellulose;
d) 0.1 to 20 wt. % of at least one compound selected from the group comprising polyvinyl acetates, ethylene vinyl acetates, polyacrylates, polyacrylamides, polymethacrylates, polyurethanes, polyvinylpyrrolidones and mixtures or corresponding copolymers thereof;
e) 0 to 30 wt. % of at least one additive; and
f) 10 to 80 wt. % water
wherein the components a)-f) add up to 100% by weight,
wherein the textile substrate can be pulled off from a surface in the dried state after application to a surface.

21. The textile substrate of claim 20, wherein the adhesive is activatable by water a multiple number of times so that the textile substrate can be removed from the substrate a multiple number of times and can be fastened to the same position again.

22. The textile substrate of claim 20, wherein the adhesive comprises 3 to 20 wt of component a).

23. The textile substrate of claim 20, wherein the adhesive comprises 15 to 45 wt. % of component b).

24. The textile substrate of claim 20, wherein the adhesive comprises 0.3 to 5 wt. % of component c).

25. The textile substrate of claim 20, wherein the adhesive comprises 1 to 10 wt. % of component d).

26. The textile substrate of claim 20, wherein the adhesive comprises 20 to 70 wt. % of component f).

27. The textile substrate of claim 20, wherein the additives are selected from the group consisting of
preservatives, from the group of isothiazolinones, from the group of pyrithiones, from the group of imidazoles, from the group of carbamates, from the group of preserving solvents, in quantities of 0 to 3 wt. %;
fillers, calcium carbonates, kaolins, aluminum hydroxides, magnesium hydroxides, hollow glass spheres, glass spheres, polymer spheres, ceramic spheres or quartz powders, in quantities of 0 to 30 wt. %;
fibers, short fiberglass fibers, cellulose fibers or polyester fibers or other synthetic textile fibers or natural textile fibers such as cotton, in quantities of 0 to 20 wt. %;
rheological additives, acrylate thickeners, cellulose thickeners, polyurethane thickeners, thickeners based on urea or polyurea or polymer sugars, in quantities of 0 to 10 wt. %;
wetting agents, surfactants from the group of non-ionic, anionic or cationic surfactants, in quantities of 0 to 10 wt. %;
anti-foaming agents, based on mineral oil; from the group of phosphates and polyphosphates or from the group of siloxanes, in quantities of 0 to 10 wt. %;
foam stabilizers, polysiloxanes, in quantities of 0 to 10 wt. %; and
mixtures thereof.

28. The textile substrate of claim 20, wherein the coating has a film thickness of 10 μm to 5 mm.

29. The textile substrate of claim 20, wherein the textile substrate is selected from the group consisting of fabrics, non-wovens, knitted fabrics, knittings, non-crimp fabrics or combinations hereof.

30. The textile substrate of claim 20, wherein the textile substrate comprises fiberglass.

31. The textile substrate of claim 20, wherein the textile substrate is a mixed textile comprising fiberglass and fibers selected from the group consisting of
mineral fibers,
carbon fibers,
synthetic fibers,
viscous fibers, cellulose fibers,
natural fibers,
metal threads; and
mixtures thereof.

32. The textile substrate of claim 20, wherein the application quantity of the adhesive amounts to 5 to 100 g/m² in the dry state.

33. The textile substrate of claim 20, wherein the textile substrate has a coat of paint on the outer side of the textile substrate remote from the coating comprising the adhesive.

34. The textile substrate of claim 20, wherein the textile substrate additionally has a vinyl coating or a PVC coating.

35. The textile substrate of claim 20, wherein further functional elements are arranged between the textile substrate and the coating and are selected from the group consisting of acoustic fleece, foam, a thermal insulation system, a heat storage system, a water-absorbing system, panel heating, an equalizing layer, an IR reflective layer, an odor-absorbing layer, a paramagnetic system, and combinations thereof.

36. A method of manufacturing a planar substrate comprising fiberglass and having a coating comprising at least one adhesive activatable by water, in which the at least one adhesive activatable by water is applied to at least one outer side of the textile substrate by means of a roller, a doctor blade, printing mechanism, screen print, curtain coater, spray nozzles or slot die, and is dried.

37. The method of claim 36, wherein the coating comprising the at least one adhesive activatable by water is applied as a foam or as a film.

38. A wallpaper comprising a textile substrate of claim 20.
